(19) United States
(12) Patent Application Publication
(10) Pub. No.: US 2021/0037791 A1
(43) Pub. Date: Feb. 11, 2021

(54) LEAD LINE ADJUSTING DEVICE FOR COMPANION ANIMAL

(71) Applicant: Firspurt Inc., Seoul (KR)

(72) Inventors: Shin-woong Park, Seoul (KR); Yong-joon Jang, Seoul (KR)

(73) Assignee: Firspurt Inc., Seoul (KR)

(21) Appl. No.: 16/682,302

(22) Filed: Nov. 13, 2019

(30) Foreign Application Priority Data
Aug. 5, 2019 (KR) 10-2019-0094906

(51) Int. Cl. A01K 27/00

(52) U.S. Cl. CPC A01K 27/004

(57) ABSTRACT

A lead line adjusting device for a companion animal is provided. The lead line adjusting device for a companion animal includes a cover part configured to include a plurality of locking means; a rotating member around which a lead line is wound; a plurality of latches configured to be coupled to one side surface of the rotating member and opened so as to be caught by a portion of the plurality of locking means while rotating about the same shaft as the rotating member when a force greater than or equal to a predetermined reference is applied to the lead line; and a spiral spring configured to apply a rotational force so that the lead line is wound around the rotating member. Accordingly, it is possible to automatically control the lead line in both directions, such as when the lead line is wound or when the lead line is unwound.

### CROSS-REFERENCE TO RELATED APPLICATION(S)

This application is based on and claims priority under 35 U.S.C. § 119 to Korean Patent Application Nos. 10-2019-0094906, filed on 5, Aug. 2019, in the Korean Intellectual Property Office, the disclosure of which is incorporated by reference herein in its entirety.

### BACKGROUND

### Field

Apparatuses and methods consistent with the disclosure relate to a lead line adjusting device for a companion animal, and more particularly, to a lead line adjusting device for a companion animal in which a lead line may be adjusted without a user's operation.

### Description of the Related Art

In modern times, the family form is changing from large families to small families with a small number of family members. According to such a small family, the number of families owning companion animals is significantly increasing.

Accordingly, there are many cases of going out with the companion animal. In this case, in order to prevent the companion animal from interfering with the passage others or to prevent the companion animal from accidentally attacking others, a lead line is generally used to control the movement of the companion animal.

However, in most cases, the user needs to increase, decrease, or fix the lead line connected to the companion animal by directly controlling a lead line adjusting device by pressing a button while carrying the lead line adjusting device.

Accordingly, the user needs to always keep an eye on the movement of the companion animal. If the companion animal suddenly tries to run away, the user needs to urgently control the lead line adjusting device to pull or fix the lead line to prevent the companion animal from running away. Therefore, from the user's point of view, there was an inconvenience in having to always carry the lead line adjusting device and respond quickly to various urgent situations that may occur.

Meanwhile, in order to solve the inconvenience of having the user always carry the lead line adjusting device, a lead line adjusting device that may be attached to the companion animal has also been developed. However, when the user misses the lead line that the user holds in his/her hand, there was a problem that a handle of the lead line adjusting device impacts the companion animal while the lead line is wound.

### SUMMARY OF THE INVENTION

Embodiments of the disclosure overcome the above disadvantages and other disadvantages not described above. Also, the disclosure is not required to overcome the disadvantages described above, and an embodiment of the disclosure may not overcome any of the problems described above.

The disclosure provides a lead line adjusting device for a companion animal in which a lead line is automatically controlled when a force greater than or equal to a predetermined reference is applied to the lead line.

According to an embodiment of the disclosure, a lead line adjusting device for a companion animal includes a cover part configured to include a plurality of locking means; a rotating member around which a lead line is wound; a plurality of latches configured to be coupled to one side surface of the rotating member and opened so as to be caught by a portion of the plurality of locking means while rotating about the same shaft as the rotating member when a force greater than or equal to a predetermined reference is applied to the lead line; and a spiral spring configured to apply a rotational force so that the lead line is wound around the rotating member.

The case in which the force greater than or equal to the predetermined reference is applied to the lead line may be one of a case in which the rotational force by the spiral spring greater than or equal to the predetermined reference is applied to the lead line and a case in which a force for unwinding the lead line greater than or equal to the predetermined reference is applied to the lead line.

When the force greater than or equal to the predetermined reference is applied to the lead line, a centrifugal force may be generated while the rotating member rotates, and the plurality of latches may be opened in response to the generated centrifugal force.

One end of each of the plurality of latches may be coupled to the rotating member through pins so that each of the plurality of latches is movable, and when the force greater than or equal to the predetermined reference is applied to the lead line, the other ends of the plurality of latches may move away from each other while moving in a direction corresponding to the generated centrifugal force.

When a portion of the other ends of the plurality of latches is caught by a portion of the plurality of locking means, while the other ends of the plurality of latches move in the direction corresponding to the generated centrifugal force, the rotating member may stop rotation in a rotation direction corresponding to the force greater than or equal to the predetermined reference.

The other portion of the other ends of the plurality of latches is not caught by the plurality of locking means such that the rotating member may be rotatable in a direction opposite to the rotation direction.

The lead line adjusting device for a companion animal may further include an elastic member configured to gather the plurality of opened latches, wherein when the rotating member stops the rotation in the rotation direction and then rotates in the direction opposite to the rotation direction, the plurality of latches are gathered by the elastic member.

When the plurality of latches are gathered by the elastic member, the rotating member may be freely rotatable in the rotation direction and the opposite direction.

The rotation direction may include one of a first rotation direction in which the rotational force by the spiral spring greater than or equal to the predetermined reference is applied to the lead line and the lead line is wound around the rotating member, and a second rotation direction in which the force for unwinding the lead line greater than or equal to the predetermined reference is applied to the lead line and the lead line is unwound from the rotating member.

The plurality of latches may include a first latch which is caught by one of the plurality of locking means when the rotating member rotates in the first rotation direction, and a second latch which is caught by one of the plurality of locking means when the rotating member rotates in the second rotation direction.

The first latch and the second latch may be disposed to move away from each other, and when any one of the first latch and the second latch is caught by one of the plurality of locking means, the other of the first latch and the second latch may not be caught by the plurality of latches means.

According to diverse embodiments of the disclosure as described above, when the user suddenly pulls the lead line or the companion animal suddenly runs away, or when the user suddenly misses the lead line, the rotation of the rotating member around which the lead line is wound is stopped and an operation in which the lead line is further stretched or wound is stopped, thereby making it possible to automatically control the lead line.

That is, it is possible to automatically control the lead line in both directions, such as when the lead line is wound or when the lead line is unwound.

### BRIEF DESCRIPTION OF THE DRAWING FIGURES

The above and/or other aspects of the disclosure will be more apparent by describing certain embodiments of the present disclosure with reference to the accompanying drawings, in which:

FIG. 1 is a view illustrating a configuration of a lead line adjusting device for a companion animal according to an embodiment of the disclosure.

FIG. 2 is a view illustrating locking means provided on a cover part according to an embodiment of the disclosure.

FIGS. 3A and 3B are views illustrating a plurality of latches provided on a rotating member according to an embodiment of the disclosure.

FIG. 4 is a view illustrating a state in which the latches are caught by the locking means according to an embodiment of the disclosure.

FIG. 5 is a view illustrating a state in which a lead line is controlled when the lead line moves in both directions according to an embodiment of the disclosure.

FIGS. 6A and 6B are views illustrating various use examples of the lead line adjusting device for a companion animal.

### DETAILED DESCRIPTION OF THE EXEMPLARY EMBODIMENTS

Hereinafter, the disclosure will be described in more detail with reference to the accompanying drawings. In addition, in describing the disclosure, when it is decided that a detailed description for the known functions or configurations related to the disclosure may obscure the gist of the disclosure, the detailed description thereof will be omitted. Further, the terms to be described below are terms defined in consideration of functions in the disclosure, and may vary according to intention or relationship of a user or an operator. Therefore, the definition thereof should be made based on the contents throughout the specification.

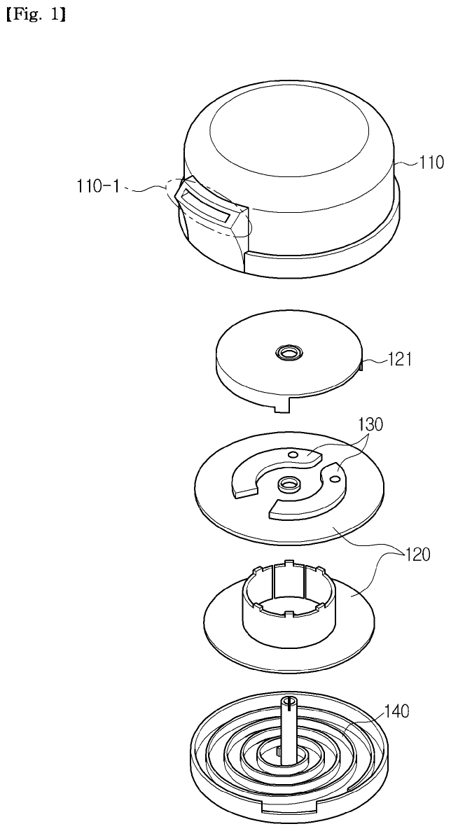

FIG. 1 is a view illustrating a configuration of a lead line adjusting device for a companion animal according to an embodiment of the disclosure.

Referring to FIG. 1, a lead line adjusting device 100 for a companion animal includes a cover part 110, a rotating member 120, a plurality of latches 130, and a spiral spring 140. Here, the lead line adjusting device 100 for a companion animal is a case fabricated in a predetermined size, having the size variously changed depending on the intended use, a size of the companion animal, and the type and length of the lead line, and having an operation space part formed therein. Such an operation space part may include the rotating member 120, the plurality of latches 130, the spiral spring 140, and the like, and may further include an internal cover 121 serving as a guide so that the plurality of latches 130 are not separated, and the like.

In addition, a housing of the lead line adjusting device 100 for a companion animal may be made of various material, and may be made of, for example, a material such as plastic, silicon, metal, ceramics, rubber, wood, or the like. In addition, the shape of the lead line adjusting device 100 for a companion animal is not limited to a cylindrical shape as illustrated in FIG. 1, and may be implemented in various shapes such as a rectangle and a hexagon.

The cover part 110 may include a plurality of locking means. Here, the cover part 110 may be implemented in a size that may cover some or all of the components of the lead line adjusting device 100 for a companion animal, and may be implemented in various materials or shapes as described above.

In addition, the cover part 110 is formed with an entrance 110-1 to allow the lead line to enter and exit toward the inside of the lead line adjusting device 100 for a companion animal. Here, a surface on which the entrance 110-1 is formed may be inclined at a predetermined angle, thereby minimizing an influence of interference that may occur when the lead line enters and exits through the entrance 110-1.

That is, in a case in which the surface on which the entrance 110-1 is formed is not inclined and forms a structure having an inverted L shape, if the lead line is pulled further in an upward direction, the influence of the interference between the lead line and the entrance 110-1 may be increased. On the contrary, in a case in which the surface on which the entrance 110-1 is formed is inclined at 45°, an allowable range of an in and out direction of the lead line is increased. That is, if the lead line is pulled in a further upward direction or a further downward direction, the influence of the interference between the lead line and the entrance 110-1 may be minimized.

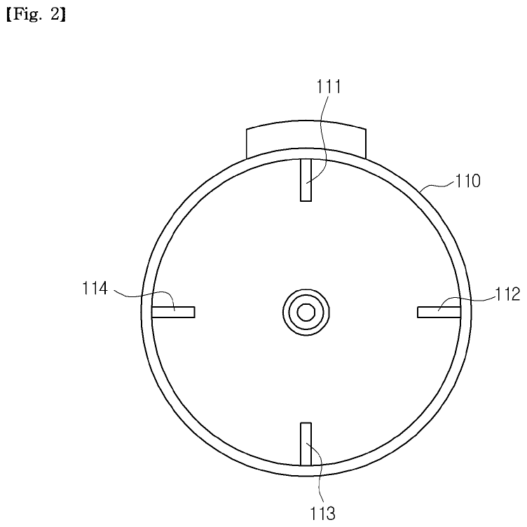

Meanwhile, as illustrated in FIG. 2, a plurality of locking means 111, 112, 113, and 114 are provided inside the cover part 110. Here, the plurality of locking means 111, 112, 113, and 114 may be implemented in a structure that protrudes in an inner direction of the cover part 110 so that the plurality of latches 130 are caught thereon while rotating. Although the plurality of locking means 111, 112, 113, and 114 are implemented in the form of four protrusions in FIG. 2, this is only illustrated as an example, and the number and shape of the locking means may be variously changed.

Specifically, the number of the plurality of locking means 111, 112, 113, and 114 illustrated in FIG. 2 is a total of four, each disposed at intervals of 90°. For example, if the number of the plurality of locking means is a total of six, the locking means may be disposed at intervals of 60°, respectively.

A portion of the plurality of latches 130 is caught by some of the plurality of locking means 111, 112, 113, and 114, such that the plurality of locking means 111, 112, 113, and 114 may limit the rotation of the rotating member 120. In more detail, it is possible to limit the rotation of the rotating member 120 in a predetermined direction, such that the lead line is no longer stretched or the lead line is no longer wound.

The rotating member 120 may be implemented in the form that the lead line may be wound, and the lead line is wound therearound. Here, the rotating member 120 only needs to be the form that allows the lead line to be wound. In FIG. 1, the rotating member 120 is implemented in the cylindrical shape, but is not limited thereto.

In addition, in FIG. 1, the rotating member 120 is illustrated as a configuration in which a disc to which the plurality of latches 130 are coupled and a cylindrical member with a base are coupled to each other, but may also be implemented as a single structure other than such a coupled structure.

Meanwhile, the lead line may vary in length, thickness, width, and material depending on the size of the companion animal and the use.

The plurality of latches 130 may be coupled to one side surface of the rotating member 120, and the plurality of latches 130 may be opened so as to be caught by a portion of the plurality of locking means 111, 112, 113, and 114 while rotating about the same shaft as the rotating member 120 when a force greater than or equal to a predetermined reference is applied to the lead line.

Specifically, the plurality of latches 130 may be coupled to one side surface of the rotating member 120, and one side surface to which the plurality of latches 130 are coupled is perpendicular to a shaft of the rotating member 120.

Accordingly, when the force greater than or equal to the predetermined reference is applied to the lead line, the lead line is wound or unwound in response to such a force. Accordingly, the rotating member 120 rotates in a direction in which the lead line is wound or unwound, and the plurality of latches 130 coupled to one side surface of the rotating member 120 also rotate in the same direction as the rotating member 120 about the same shaft as the rotating member 120.

In addition, the plurality of latches 130 are opened while rotating, and a portion of the plurality of opened latches 130 are caught by a portion of the plurality of locking means 111, 112, 113, and 114 provided on the cover part 110.

Specifically, when the force greater than or equal to the predetermined reference is applied to the lead line, a centrifugal force is generated while the rotating member 120 rotates, and the plurality of latches 130 may be opened in response to the generated centrifugal force.

That is, an angle at which the plurality of latches 130 are opened may be changed in correspondence with the magnitude of the generated centrifugal force, and as the magnitude of the generated centrifugal force is increased, the angle at which the plurality of latches 130 are opened is increased.

Meanwhile, in regard to the generated centrifugal force when the force greater than or equal to the predetermined reference is applied to the lead line, the case in which the force greater than or equal to the predetermined reference is applied to the lead line refers to one of a case in which the rotational force by the spiral spring 140 this is greater than or equal to the predetermined reference is applied to the lead line and a case in which a force for unwinding the lead line that is greater than or equal to the predetermined reference is applied to the lead line.

For example, it is assumed that the user suddenly misses the lead line in his/her hand in a state in which the user is away from the companion animal and the lead line is unwound. First, in the case in which the user is away from the companion animal and the lead line is unwound, an elastic force is gradually increased as the lead line is unwound to the spiral spring 140 in a direction in which the lead line is wound around the rotating member 120. In such a state in which the elastic force is increased, when the user suddenly misses the lead line in his/her hand, the spiral spring 140 strongly adds a rotational force to the rotating member 120 by the elastic force such that the lead line is wound around the rotating member 120.

In addition, when such a rotational force is greater than or equal to the force enough to open the plurality of latches 130 so that at least the plurality of latches 130 may be caught by the plurality of locking means, it may be seen that the force greater than or equal to the predetermined reference is applied to the lead line.

In addition, for example, it is assumed that the companion animal suddenly moves away from the user or the user suddenly pulls the lead line. Such a case corresponds to a case in which the lead line is suddenly unwound from the rotating member 120. In this case, a force for unwinding the lead line from the rotating member 120 may be strongly applied to the rotating member 120.

In addition, when such a force for unwinding the lead line from the rotating member 120 is greater than or equal to the force enough to open the plurality of latches 130 so that at least the plurality of latches 130 may be caught by the plurality of locking means, it may be seen that the force greater than or equal to the predetermined reference is applied to the lead line.

That is, the case in which the force greater than or equal to the predetermined reference is applied to the lead line may include both the case in which the force greater than or equal to the predetermined reference is applied in the direction in which the lead line is unwound and the case in which the force greater than or equal to the predetermined reference is applied in the direction in which the lead line is wound, as in the examples described above.

In addition, as long as the force greater than or equal to the predetermined reference is applied to the lead line either in the direction in which the lead line is unwound or in the direction in which the lead line is wound, the portion of the plurality of latches 130 are caught by the plurality of locking means 111, 112, 113, and 114, such that the rotation of the rotating member 120 may be controlled.

Meanwhile, FIG. 2 is a view illustrating locking means provided on a cover part according to an embodiment of the disclosure. The locking means 111, 112, 113, and 114 provided on the cover part 110 have been described with reference to FIG. 1 and a detailed description thereof is thus omitted.

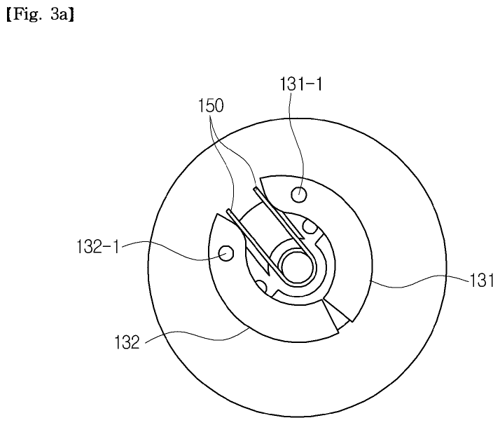

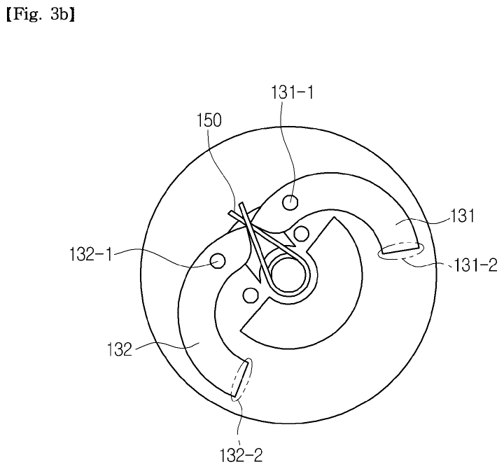

FIGS. 3A and 3B are views illustrating a plurality of latches provided on a rotating member according to an embodiment of the disclosure.

Referring to FIG. 3A, one end of each of the plurality of latches 131 and 132 is coupled to the rotating member 120 through pins 131-1 and 132-1 so that each of the plurality of latches 131 and 132 may move.

That is, only one end of each of the plurality of latches 131 and 132 is coupled to the rotating member 120 through the pins 131-1 and 132-1, such that each of the plurality of latches 131 and 132 may move around the pins 131-1 and 132-1 in response to the centrifugal force generated while the rotating member 120 rotates.

Accordingly, referring to FIG. 3B, when the force greater than or equal to the predetermined reference is applied to the lead line as described above, the other ends 131-2 and 132-2 of the plurality of latches 131 and 132 move away from each other while moving in a direction corresponding to the generated centrifugal force.

That is, only one end of each of the plurality of latches 131 and 132 is coupled to the rotating member 120 through the pins 131-1 and 132-1, such that each of the plurality of latches 131 and 132 moves around the pins 131-1 and 132-1, and the other ends 131-2 and 132-2 of the plurality of latches 131 and 132 are forced to move away from each other in the direction corresponding to the centrifugal force because one end of each of the plurality of latches 131 and 132 is fixed by the pins 131-1 and 132-1.

Meanwhile, the lead line adjusting device 100 for a companion animal according to an embodiment of the disclosure further includes an elastic member 150 for gathering the plurality of opened latches 130.

Accordingly, as illustrated in FIG. 3A, in a state in which there is no rotation of the rotating member 120, the plurality of latches 131 and 132 maintain a state in which the plurality of latches 131 and 132 are gathered together by the elastic member 150.

However, when the force greater than or equal to the predetermined reference is applied to the lead line, the centrifugal force generated by the rotation of the rotating member 120 is applied to the plurality of latches 131 and 132 more strongly than an elastic force of the elastic member 150 to gather the plurality of latches 130, such that the plurality of latches 131 and 132 are opened as illustrated in FIG. 3B despite the elastic force of the elastic member 150. Of course, when the rotation of the rotating member 120 is stopped, the elastic force of the elastic member 150 acts on the plurality of latches 131 and 132 again, and the plurality of latches 131 and 132 are gathered together as illustrated in FIG. 3A.

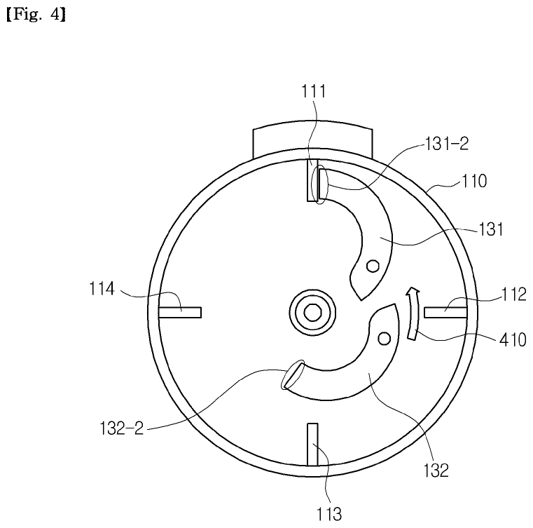

Meanwhile, FIG. 4 is a view illustrating a state in which the latches are caught by the locking means according to an embodiment of the disclosure.

FIG. 4 is a view illustrating a state in which the plurality of latches 131 and 132 are caught by the plurality of locking means 111, 112, 113, and 114, when the inside of the cover part 110 is viewed from the bottom in an upward direction.

Specifically, when a portion 131-2 of the other ends 131-2 and 132-2 of the plurality of latches 131 and 132 is caught by a portion 111 of the plurality of locking means 111, 112, 113, and 114, while the other ends of the plurality of latches 131 and 132 move in the direction corresponding to the generated centrifugal force, that is, are opened, the rotating member 120 stops rotation in a rotation direction 410 corresponding to the force greater than or equal to the predetermined reference.

In this case, the other portion 132-2 of the other ends 131-2 and 132-2 of the plurality of latches 131 and 132 is not caught by the plurality of locking means 111, 112, 113, and 114, such that the rotating member 120 may rotate in a direction opposite to the rotation direction 410 corresponding to the force greater than or equal to the predetermined reference.

Accordingly, when the rotating member 120 stops the rotation in the rotation direction 410 corresponding to the force greater than or equal to the predetermined reference and then rotates in the direction opposite to the rotation direction 410 corresponding to the force greater than or equal to the predetermined reference, the plurality of latches 131 and 132 may be gathered by the elastic member 150.

Here, the reason why all of the other ends 131-2 and 132-2 of the plurality of latches 131 and 132 are not caught by the portion of the plurality of locking means 111, 112, 113, and 114 is as follows. When all of the other ends 131-2 and 132-2 of the plurality of latches 131 and 132 are caught by the portion of the plurality of locking means 111, 112, 113, and 114, it is impossible for the rotating member 120 to rotate in the rotation direction 410 corresponding to the force greater than or equal to the predetermined reference and the opposite direction, that is, in any direction and the rotation of the rotating member 120 may not be controlled.

Accordingly, the plurality of latches 131 and 132 according to an embodiment of the disclosure are opened in the range in which all of the other ends 131-2 and 132-2 of the plurality of latches 131 and 132 are not caught by the portion of the plurality of locking means 111, 112, 113, and 114.

For example, when the user suddenly misses the lead line in his hand in a state in which the user is away from the companion animal and the lead line is unwound, a rotational force to wind the lead line around the rotating member 120 is strongly applied to the rotating member 120 by the elastic force by the spiral spring 140. Accordingly, the rotating member 120 rotates in the rotation direction 410 corresponding to the rotational force.

In addition, the portion 131-2 of the other ends 131-2 and 132-2 of the plurality of latches 131 and 132 is caught by the portion 111 of the plurality of locking means 111, 112, 113, and 114, while the other ends 131-2 and 132-2 of the plurality of latches 131 and 132 move in the direction corresponding to the generated centrifugal force, that is, are opened in response to the centrifugal force generated by the rotation of the rotating member 120, such that the rotating member 120 stops the rotation in the rotation direction 410 corresponding to the rotational force, that is, the direction in which the lead line is wound.

Therefore, since the rotating member 120 stops the rotation in the direction in which the lead line is wound even in the case in which the user suddenly misses the lead line in his hand, it is possible to prevent a situation in which the lead line is wound around the rotating member 120, thereby impacting on the companion animal.

However, the other portion 132-2 of the other ends 131-2 and 132-2 of the plurality of latches 131 and 132 is not caught by the plurality of locking means 111, 112, 113, and 114, such that the rotating member 120 may rotate in a direction opposite to the direction 410 corresponding to the rotational force, that is, a direction in which the lead line is unwound.

That is, even in the case in which the user suddenly misses the lead line in his hand, the lead line is no longer wound around the rotating member 120. Thereafter, the user may pull the lead line in a direction of unwinding the lead line from the rotating member 120 by holding the lead line again, or the lead line may be unwound while the companion animal moves away from the user.

In addition, when the rotating member 120 rotates in the direction in which the lead line is unwound, the plurality of latches 131 and 132 are gathered again by the elastic member 150.

In addition, when the plurality of latches 130 are gathered by the elastic member 150, the rotating member 120 may freely rotate again in the direction in which the lead line is unwound and in the direction in which the lead line is wound.

Therefore, in this case, the lead line may be freely unwound or wound again such that the companion animal may freely move.

In addition, for example, when the companion animal suddenly moves away from the user or the user suddenly pulls the lead line, a force for unwinding the lead line from the rotating member 120 may be strongly applied to the rotating member 120. Accordingly, the rotating member 120 rotates in the rotation direction 410 corresponding to the force for unwinding the lead line.

In addition, the portion 131-2 of the other ends 131-2 and 132-2 of the plurality of latches 131 and 132 is caught by the portion 111 of the plurality of locking means 111, 112, 113, and 114, while the other ends 131-2 and 132-2 of the plurality of latches 131 and 132 move in the direction corresponding to the generated centrifugal force, that is, are opened in response to the centrifugal force generated by the rotation of the rotating member 120, such that the rotating member 120 stops the rotation in the direction 410 corresponding to the force for unwinding the lead line, that is, the direction in which the lead line is unwound.

Therefore, even in the case in which the companion animal suddenly moves away from the user or the user suddenly pulls the lead line, the rotating member 120 stops the rotation in the direction in which the lead line is unwound. As a result, the companion animal is no longer able to move away from the user such that the control of the companion animal is possible and possible accidents may be prevented in advance.

However, the other portion 132-2 of the other ends 131-2 and 132-2 of the plurality of latches 131 and 132 is not caught by the plurality of locking means 111, 112, 113, and 114, such that the rotating member 120 may rotate in a direction opposite to the direction 410 corresponding to the force for unwinding the lead line, that is, a direction in which the lead line is wound.

That is, even in the case in which the companion animal suddenly moves away from the user, the lead line is no longer unwound from the rotating member 120. Thereafter, the lead line may be wound while the companion animal moves again in a direction closer to the user or the user moves toward the companion animal.

In addition, when the rotating member 120 rotates in the direction in which the lead line is wound, the plurality of latches 131 and 132 are gathered again by the elastic member 150.

In addition, when the plurality of latches 130 are gathered by the elastic member 150, the rotating member 120 may freely rotate again in the direction in which the lead line is unwound and in the direction in which the lead line is wound.

Therefore, in this case, the lead line may be freely unwound or wound again such that the companion animal may freely move.

As described above, the lead line adjusting device 100 for a companion animal according to an embodiment of the disclosure may control the lead line to no longer unwind or wind when the lead line is suddenly unwound or wound, and may also restore the lead line so that the lead line is freely unwound or wound through an opposite operation.

Meanwhile, the rotation direction in the example described above may include one of a first rotation direction in which the rotational force by the spiral spring 140 greater than or equal to the predetermined reference is applied to the lead line and the lead line is wound around the rotating member 120, and a second rotation direction in which the force for unwinding the lead line greater than or equal to the predetermined reference is applied to the lead line and the lead line is unwound from the rotating member 120.

In addition, the plurality of latches 130 may include a first latch 131 which is caught by one of the plurality of locking means 111, 112, 113, and 114 when the rotating member 120 rotates in the first rotation direction, and a second latch 132 which is caught by one of the plurality of locking means 111, 112, 113, and 114 when the rotating member 120 rotates in the second rotation direction.

Here, the first latch 131 and the second latch 132 are disposed to move away from each other. As described above, the first latch 131 and the second latch 132 may be implemented so that one end of each of the first latch 131 and the second latch 132 is fixed by the pin and the other end of each of the first latch 131 and the second latch 132 may move in response to the centrifugal force.

In addition, when any one of the first latch 131 and the second latch 132 is caught by one of the plurality of locking means, the other of the first latch 131 and the second latch 132 is not caught by the plurality of locking means.

For example, when the force greater than or equal to the predetermined reference is applied to the lead line and the rotating member 120 rotates in the first rotation direction, the first latch 131 is caught by one 111 of the plurality of locking means 111, 112, 113, and 114 such that the rotating member 120 may no longer rotate in the first rotation direction. Accordingly, the lead line is no longer wound around the rotating member 120.

However, the second latch 132 is not caught by the plurality of locking means 111, 112, 113, and 114, thereby making it possible to rotate the rotating member 120 in the second rotation direction opposite to the first rotation direction. Accordingly, the lead line may be unwound from the rotating member 120.

In the same manner, when the force greater than or equal to the predetermined reference is applied to the lead line and the rotating member 120 rotates in the second rotation direction, the second latch 132 is caught by one 111 of the plurality of locking means 111, 112, 113, and 114 such that the rotating member 120 may no longer rotate in the second rotation direction. Accordingly, the lead line is no longer unwound from the rotating member 120.

However, the first latch 131 is not caught by the plurality of locking means 111, 112, 113, and 114, thereby making it possible to rotate the rotating member 120 in the first rotation direction opposite to the second rotation direction. Accordingly, the lead line may be wound around the rotating member 120.

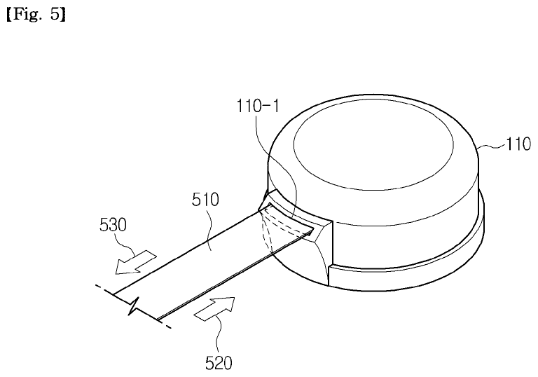

FIG. 5 is a view illustrating a state in which a lead line is controlled when the lead line moves in both directions according to an embodiment of the disclosure.

For example, when the companion animal suddenly moves away from the user, the force greater than or equal to the predetermined reference is applied to a lead line 510 in a direction 530 in which the lead line is unwound. As described above, the rotating member 120 stops the rotation in the direction 530 in which the lead line is unwound such that the lead line 510 is no longer unwound. Accordingly, the companion animal may no longer move away from the user.

In the same manner, the example described above may be applied to the case in which the user suddenly pulls the lead line in the same manner.

In addition, for example, when the user suddenly misses the lead line 510 in a state in which the user and the companion animal are at some distance, the rotational force of the spiral spring 140 greater than or equal to the predetermined reference is applied to a lead line 510 in a direction 520 in which the lead line is wound. As described above, the rotating member 120 stops the rotation in the direction 520 in which the lead line is wound such that the lead line 510 is no longer wound. Accordingly, it is possible to prevent the handle of the lead line held by the user from impacting on the companion animal by being wound into the lead line adjusting device 100 for a companion animal.

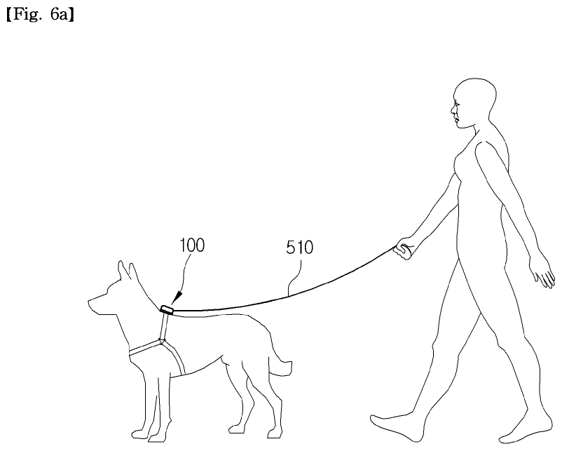

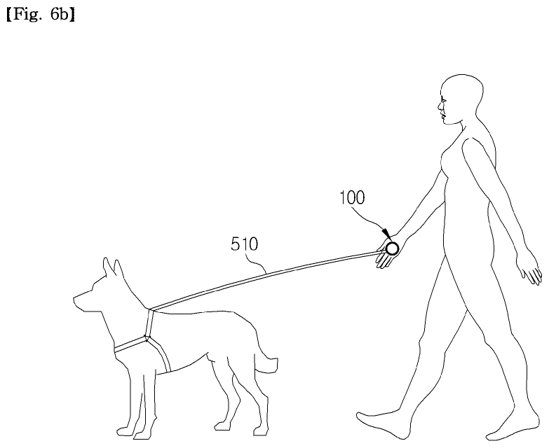

FIGS. 6A and 6B are views illustrating various use examples of the lead line adjusting device for a companion animal.

Referring to FIG. 6A, the lead line adjusting device 100 for a companion animal according to an embodiment of the disclosure may be attached to a component (e.g., a harness) surrounding the companion animal, and the user may control the companion animal through the lead line 510 while holding the lead line 510 without requiring a separate device or holding a component such as the handle connected to the lead line 510.

In this case, the lead line adjusting device 100 for a companion animal may be implemented, for example, as a part of the harness. The lead line adjusting device 100 for a companion animal may be attachable to any part of the harness without limitation. Of course, the lead line adjusting device 100 for a companion animal may be attached to any article or component that may be used for the companion animal as well as the harness.

Referring to FIG. 6B, the lead line adjusting device 100 for a companion animal according to an embodiment of the disclosure may also be implemented in a form that the user may directly hold in his/her hand and use.

Also, in this case, the user does not need to control the lead line by operating a separate switch or button and may control the companion animal by using the lead line 510 through the operation of the lead line adjusting device 100 for a companion animal 100 described above, even if the user just holds the lead line adjusting device 100 for a companion animal in his/her hand.

As described above, when the lead line adjusting device 100 for a companion animal according to an embodiment of the disclosure is used, there is no need for the user to operate the button or switch separately, nor does the user need to carry a separate lead line adjusting device, thereby making it possible to increase convenience of the user.

Although the embodiments of the disclosure have been illustrated and described hereinabove, the disclosure is not limited to the above-mentioned specific embodiments, but may be variously modified by those skilled in the art to which the disclosure pertains without departing from the scope and spirit of the disclosure as disclosed in the accompanying claims. These modifications should not be understood individually from the technical idea or viewpoint of the disclosure.

What is claimed is:

1. A lead line adjusting device for a companion animal, comprising:
a cover part configured to include a plurality of locking means;
a rotating member around which a lead line is wound;
a plurality of latches configured to be coupled to one side surface of the rotating member and opened so as to be caught by a portion of the plurality of locking means while rotating about the same shaft as the rotating member when a force greater than or equal to a predetermined reference is applied to the lead line; and
a spiral spring configured to apply a rotational force so that the lead line is wound around the rotating member.

2. The lead line adjusting device for a companion animal as claimed in claim 1, wherein the case in which the force greater than or equal to the predetermined reference is applied to the lead line is one of a case in which the rotational force by the spiral spring greater than or equal to the predetermined reference is applied to the lead line and a case in which a force for unwinding the lead line greater than or equal to the predetermined reference is applied to the lead line.

3. The lead line adjusting device for a companion animal as claimed in claim 2, wherein when the force greater than or equal to the predetermined reference is applied to the lead line, a centrifugal force is generated while the rotating member rotates, and the plurality of latches are opened in response to the generated centrifugal force.

4. The lead line adjusting device for a companion animal as claimed in claim 3, wherein one end of each of the plurality of latches is coupled to the rotating member through pins so that each of the plurality of latches is movable, and
when the force greater than or equal to the predetermined reference is applied to the lead line, the other ends of the plurality of latches move away from each other while moving in a direction corresponding to the generated centrifugal force.

5. The lead line adjusting device for a companion animal as claimed in claim 4, wherein when a portion of the other ends of the plurality of latches is caught by a portion of the plurality of locking means, while the other ends of the plurality of latches move in the direction corresponding to the generated centrifugal force, the rotating member stops rotation in a rotation direction corresponding to the force greater than or equal to the predetermined reference.

6. The lead line adjusting device for a companion animal as claimed in claim 5, wherein the other portion of the other ends of the plurality of latches is not caught by the plurality of locking means such that the rotating member is rotatable in a direction opposite to the rotation direction.

7. The lead line adjusting device for a companion animal as claimed in claim 6, further comprising an elastic member configured to gather the plurality of opened latches,
wherein when the rotating member stops the rotation in the rotation direction and then rotates in the direction opposite to the rotation direction, the plurality of latches are gathered by the elastic member.

8. The lead line adjusting device for a companion animal as claimed in claim 7, wherein when the plurality of latches are gathered by the elastic member, the rotating member is freely rotatable in the rotation direction and the opposite direction.

9. The lead line adjusting device for a companion animal as claimed in claim 8, wherein the rotation direction includes one of a first rotation direction in which the rotational force by the spiral spring greater than or equal to the predetermined reference is applied to the lead line and the lead line is wound around the rotating member, and a second rotation direction in which the force for unwinding the lead line greater than or equal to the predetermined reference is applied to the lead line and the lead line is unwound from the rotating member.

10. The lead line adjusting device for a companion animal as claimed in claim 9, wherein the plurality of latches include a first latch which is caught by one of the plurality of locking means when the rotating member rotates in the first rotation direction, and a second latch which is caught by one of the plurality of locking means when the rotating member rotates in the second rotation direction.

11. The lead line adjusting device for a companion animal as claimed in claim 10, wherein the first latch and the second latch are disposed to move away from each other, and
when any one of the first latch and the second latch is caught by one of the plurality of locking means, the other of the first latch and the second latch is not caught by the plurality of locking means.
